(19) United States
(12) Patent Application Publication
(10) Pub. No.: US 2005/0162705 A1
(43) Pub. Date: Jul. 28, 2005

(54) Network system and a method for registering an abbreviated number thereof

(75) Inventor: Sun-jin Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/038,265

(22) Filed: Jan. 21, 2005

(30) Foreign Application Priority Data
Jan. 26, 2004 (KR) 2004-4779

(51) Int. Cl. H04N 1/00

(52) U.S. Cl. 358/402; 358/440

(57) ABSTRACT

A network system and a method for registering an abbreviated number are provided. The network system for controlling a plurality of peripherals connected to a host device through a network comprises a first interface part for supplying a communication interface for communicating with the plurality of peripherals; a network driver part for supplying a menu screen for inputting abbreviated information which will be registered in a selected peripheral among the plurality of peripherals, the abbreviated information comprises at least one of an e-mail address and a facsimile number; an input part for inputting the abbreviated information; and a first control part for controlling the network driver part so that the menu screen is supplied upon receipt of a signal from the input part, the signal requesting registration of an abbreviated number in the peripheral, and controlling the first interface part so that the abbreviated information input from the input part is transmitted to the peripheral based on the menu screen.

### PRIORITY

This application claims the benefit under 35 U.S.C. 119(a) of Korean Application No. 2004-04779, filed Jan. 26, 2004, in the Korean Intellectual Property Office, the entire contents of which is incorporated herein by reference.

### BACKGROUND OF THE INVENTION

1. Field of the Invention

The present invention relates to a network system and a method for registering an abbreviated number thereof. More particularly, the present invention relates to a network system which can be input with information on an abbreviated number with respect to an e-mail address and a facsimile number to be registered in a network multi-function apparatus, using a network driver installed on a host device, and a method for registering the abbreviated number.

2. Description of the Related Art

General multi-function apparatuses are apparatuses in which several office automation devices such as printers, scanners, copiers and facsimiles that perform independent functions are combined into one device. The multi-function apparatuses comprise communication modules such as a printing module, a scanning module, and a modem so that functions of scanners and photocopiers including printers and facsimiles, can be compositely performed by one apparatus.

Conventional facsimiles or the multi-function apparatuses having the functions of facsimiles offers an abbreviated dialing function for fast and easy dialing of facsimile numbers in frequent use. In using a conventional method for registering an abbreviated number, a user has to thoroughly study a manual of the product first, select an abbreviated key provided in an operation panel on a housing of the multi-function apparatus, designate an abbreviated number for a facsimile number for registration, and input the facsimile number for registration. The user can then dial the facsimile number of a receiving end simply by selecting the registered abbreviated number.

As described above, the conventional method is troublesome for the user to use since the user has to register in person abbreviated numbers corresponding to the facsimile numbers or e-mail addresses using the operation panel provided on the housing of the multi-function apparatus. For registration of e-mail addresses, especially, the operation panel needs to be equipped with letter keys for input of the e-mail addresses, or other dedicated input means.

Originator information, which is transmitted during the facsimile transmission, refers to systemic information input to a facsimile which performs text transmission, other than information on the user who transmits the text. Therefore, to transmit the originator information during the facsimile transmission, the user has to write the originator information at a certain portion of a document by hand.

### SUMMARY OF THE INVENTION

An aspect of the present invention is to solve at least the above problems and/or disadvantages and to provide at least the advantages described below. Accordingly, an aspect of the present invention is to provide a network system which enables convenient input of information on an e-mail address and a facsimile number to be registered in a network multi-function apparatus, using a network driver installed on a host computer, and a method for registering an abbreviated number.

In order to achieve the above-described aspects of the present invention, there is provided a network system for controlling a plurality of peripherals connected to a host device through a network. The network system comprises a first interface part for supplying a communication interface for communicating with the plurality of peripherals; a network driver part for supplying a menu screen for inputting abbreviated information which will be registered in a selected peripheral among the plurality of peripherals, the abbreviated information on e-mail address and a facsimile number; an input part for inputting the abbreviated information; and a first control part for controlling the network driver part so that the menu screen is supplied upon receipt of a signal from the input part, the signal requesting registration of an abbreviated number in the peripheral, and controlling the first interface part so that the abbreviated information input from the input part is transmitted to the peripheral based on the menu screen.

The abbreviated information comprises at least one of a receiver name, an e-mail address, a facsimile number, a document to be transmitted, and originator information. The network driver part allocates an abbreviated number to the input abbreviated information.

The network driver part displays a list of the plurality of peripherals connected to the host device through the network according to the requesting signal by a user, the list separately showing the peripherals registered for frequent use and unregistered peripherals.

The plurality of peripherals comprise a second interface part for supplying a communication interface for communicating with the host device; a storage part for storing the abbreviated information allocated with the abbreviated number; and a second control part, when the abbreviated information is received from the host device through the second interface, for processing such that the received abbreviated information is stored in the storage part.

The plurality of peripherals further comprise a first communication module for transceiving a predetermined facsimile document, and when a predetermined abbreviated number is input by selection of a document transmission function for transmitting a predetermined document, the second control part reads at least one of an e-mail address and a facsimile number corresponding to the input abbreviated number, and transmits the document to at least one of the read e-mail address and the facsimile number.

In order to achieve another aspect of the present invention, there is provided a method for registering an abbreviated number in a network system which controls a plurality of peripherals connected to a host device through a network. The method comprising the steps of receiving a signal requesting registration of an abbreviated number for at least one of an e-mail address and a facsimile number; upon receipt of the request signal, supplying a menu screen for inputting abbreviated information on at least one of the e-mail address and the facsimile number; inputting the abbreviated information for registration in a selected peripheral among the plurality of peripherals based on the menu screen; allocating an abbreviated number to the input abbreviated information; and transmitting the abbreviated information allocated with the abbreviated number to the selected peripheral.

The method further comprises the steps of receiving the abbreviated information transmitted from the host device; and storing the received abbreviated information in a storage device.

The method may further comprise the steps of selecting a document transmission mode for transmitting a predetermined document to an external device; inputting an abbreviated number corresponding to information of a recipient; reading at least one of the e-mail address and the facsimile number which are stored corresponding to the abbreviated number input from the storage device; and transmitting the read document to at least one of the e-mail address and the facsimile number.

The menu screen is supplied by a network driver part provided in the host device to manage the plurality of peripherals.

### BRIEF DESCRIPTION OF THE DRAWING FIGURES

The above aspect and other features of the present invention will become more apparent by describing in detail exemplary embodiments thereof with reference to the accompanying drawing figures, wherein;

FIG. 1 is a view schematically showing the structure of a network system according to an embodiment of the present invention;

FIG. 2 is a schematic block diagram of a host computer shown in FIG. 1;

FIG. 3A illustrates an exemplary screen displayed on a display device during the operation of a network driver part shown in FIG. 2;

FIG. 3B is a flowchart for explaining the operation procedure of the network driver part shown in FIG. 2;

FIGS. 4A to 4C illustrate exemplary menu screens supplied by the network driver part of FIG. 2 when registration of abbreviated number with respect to an e-mail address is requested;

FIG. 5 is a block diagram schematically showing a first multi-function apparatus shown in FIG. 1;

FIG. 6 is a flowchart for explaining a method for registering a facsimile number of methods for registration of abbreviated numbers according to an embodiment of the present invention;

FIGS. 7A and 7B illustrate exemplary menu screens supplied by the network driver part of FIG. 2 when registration of abbreviated number with respect to a facsimile number is requested; and

FIG. 8 is a flowchart for explaining a method for facsimile transmission using a first multi-function apparatus of FIG. 5.

### DETAILED DESCRIPTION OF THE EXEMPLARY EMBODIMENTS

Hereinafter, certain embodiments of the present invention will be described in detail with reference to the accompanying drawing figures.

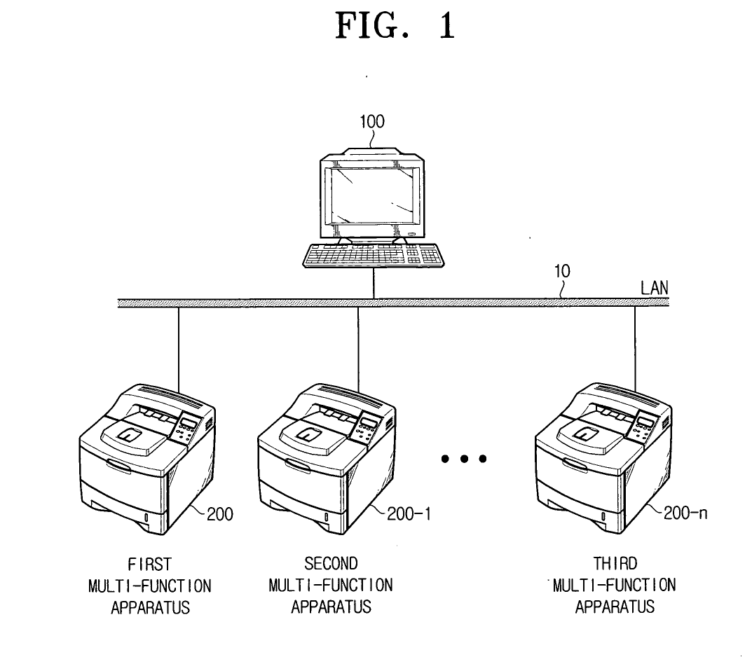

FIG. 1 schematically shows the structure of a network system according to an embodiment of the present invention.

Referring to FIG. 1, the network system comprises a host device 100 and a plurality of peripheral devices 200 to 200-n. The host device 100 and the peripheral devices 200 to 200-n are interconnected through a local area network (LAN) 10. The host device 100 transmits a job document to a registered one of the plurality of peripheral devices 200 to 200-n connected by the LAN 10. A host computer comprising a device driver related to the registered peripheral devices 200 to 200-n can be an example for the host device 100.

The plurality of peripheral devices 200 to 200-n transmit document data transmitted from the host device 100 to an external device using a facsimile number or an e-mail address. For example, an image forming apparatus capable of transmitting facsimile and e-mail can be applied for the peripheral devices 200 to 200-n.

Hereinbelow, an embodiment will be described using a host computer for the host device 100, and a multi-function apparatus for the peripheral devices 200 to 200-n, the multi-function apparatus comprises functions of a photocopier, a printer, a scanner, a facsimile and a function for e-mail management.

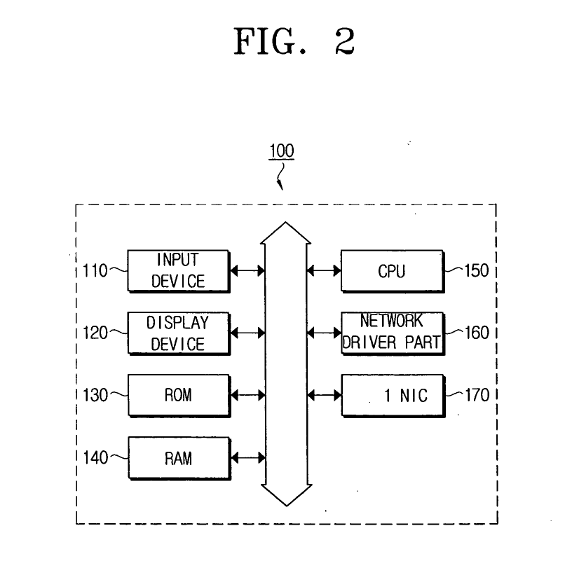

FIG. 2 is a schematic block diagram illustrating the host computer 100 of FIG. 1.

Referring to FIG. 2, the host computer 100 comprises an input device 110, a display device 120, a read-only memory (ROM) 130, a random access memory (RAM) 140, a central processing unit (CPU) 150, a network driver part 160, and a first network interface card (NIC) 170.

The input device 110 applies a key input signal operated by a user to the CPU 150, and may comprise a keyboard, a mouse, and a touch panel.

The display device 120 is a general monitor such as a cathode ray tube (CRT) and a liquid crystal display (LCD), which displays the operation states of the host computer 150 according to a control of the CPU 150.

The ROM 130 is a nonvolatile memory element, which stores a variety of controlling programs for realizing functions of the host computer 100.

The RAM 140 is a volatile memory element, which temporarily stores data resulting from the performance of the programs by the CPU 150.

The CPU 150 controls overall operations of the host computer 100 according to the controlling programs in the ROM 130.

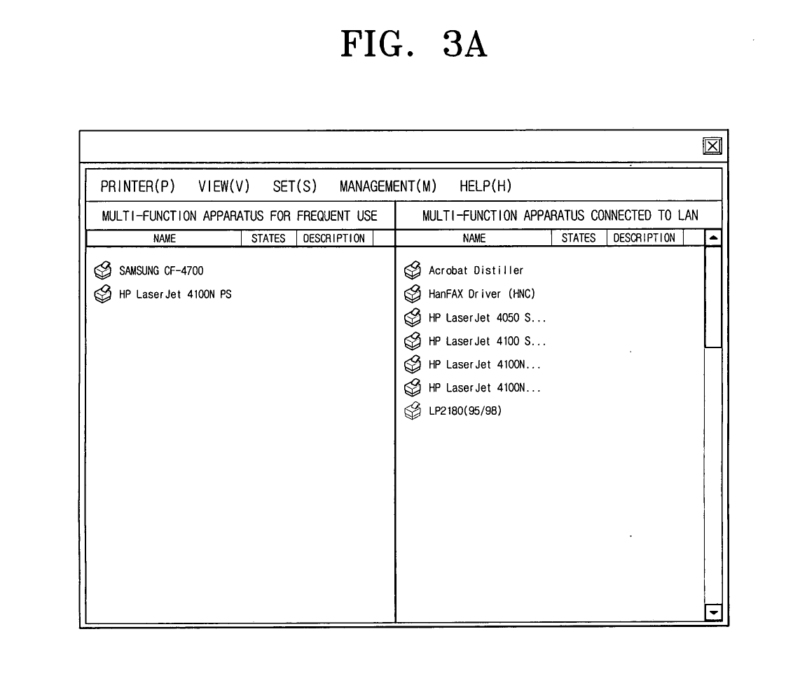

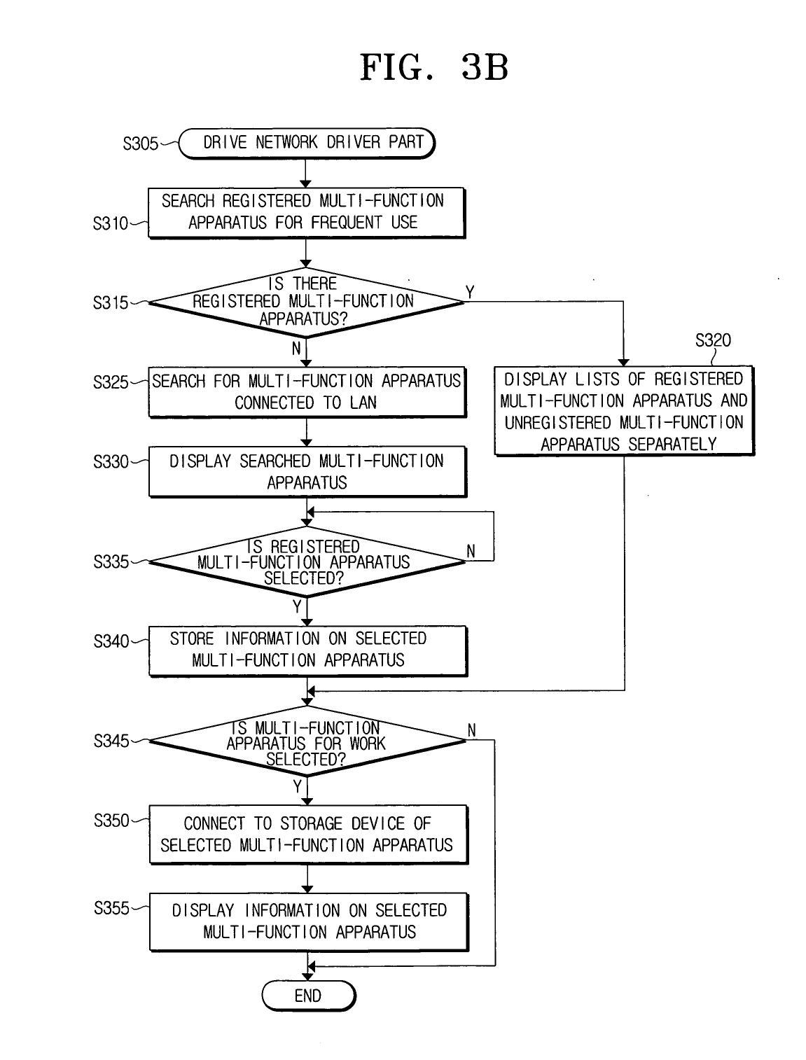

The network driver part 160 manages a multi-function apparatus driver (not shown) related to the plurality of peripheral devices 200 to 200-n connected to the host computer 100 through the LAN 10. For this, the network driver part 160 searches for and offers the plurality of peripheral devices 200 to 200-n connected through the LAN 10 upon request of the user. Here, the network driver part 160 separately displays a list of multi-function apparatuses registered for frequent use (hereinbelow, referred to as ‘registered list’) and a list of all multi-function apparatuses connected through the LAN 10 (hereinbelow, referred to as an ‘all list’), as shown in FIG. 3A. Therefore, the user does not have to perform a search each time for a multi-function apparatus among all the connected multi-function apparatuses. Specifically, with reference to FIG. 3B, when the network driver part 160 is driven at step S305, the network driver part 160 searches a memory (not shown) for a multi-function apparatus registered for frequent use at steps S310 and S315. The memory is allotted to store information regarding the network driver part 160, and for the memory, the ROM 130 or any dedicated memory can be used. If the multi-function apparatus is registered for frequent use as a result of the search, the network driver part 160 separately displays the registered list and the all list, as shown in FIG. 3A at step S320.

If there is no multi-function apparatus registered for frequent use as a result of step S315, the network driver part 160 searches for and displays the all list at steps S325 and S330. When a multi-function apparatus to be registered is selected from the all list at step S335, the network driver part 160 stores information on the selected multi-function apparatus in the memory allocated for the network driver part 160 at step S340. When a multi-function apparatus to be used is selected from the registered list or the all list at step S345, the network driver part 160 connects with a storage device provided in the selected multi-function apparatus to be used at step S350, reads information stored in the storage device and offers the read information to the user through the display device 120 at step S355.

In addition, the network driver part 160 offers a user interface screen for input of abbreviated information regarding at least one of the e-mail address and the facsimile number that will be registered in the multi-function apparatus selected among the plurality of connected multi-function apparatuses 200 to 200-n. Hereinbelow, there will be described an example where the first multi-function apparatus 200 is selected from among the plurality of multi-function apparatuses 200 to 200-n of FIG. 1 for a predetermined job.

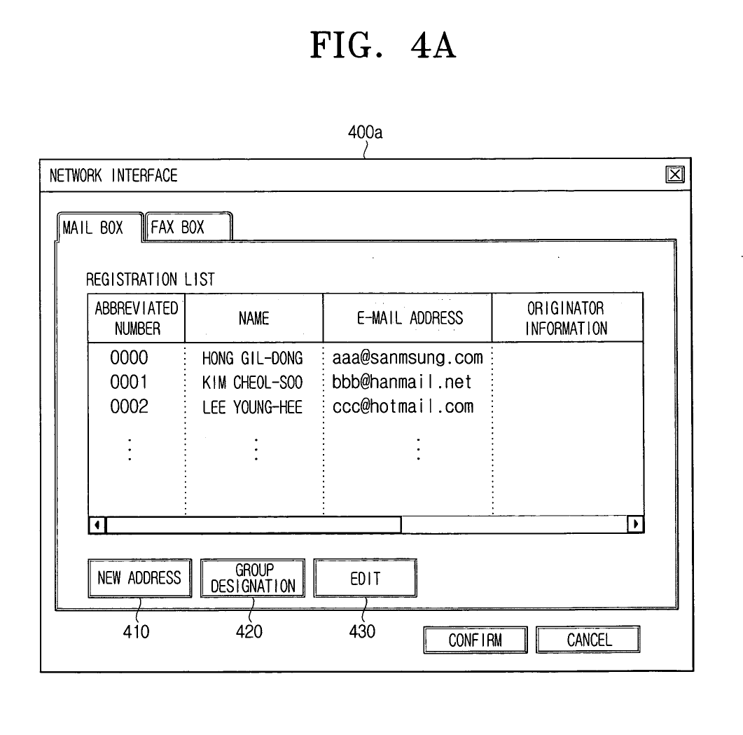

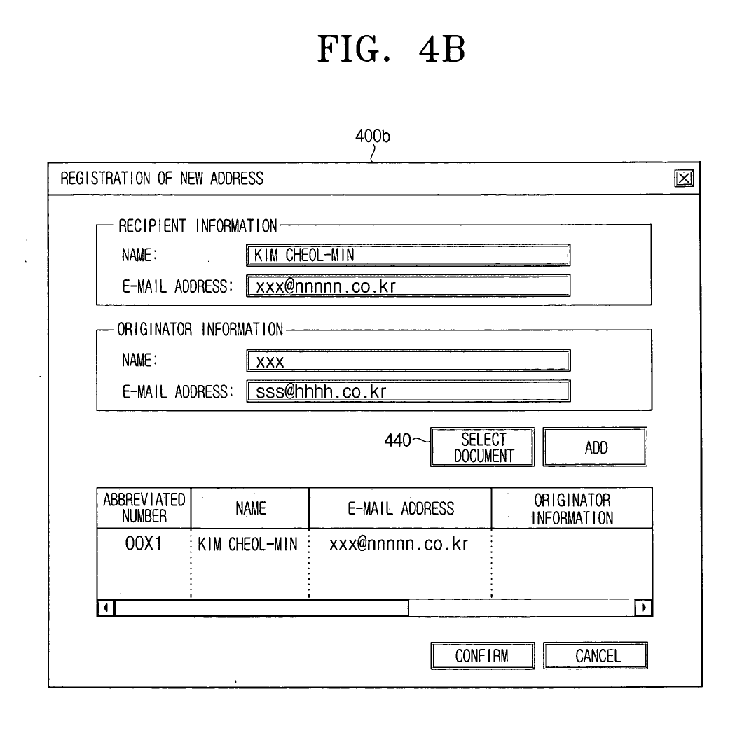

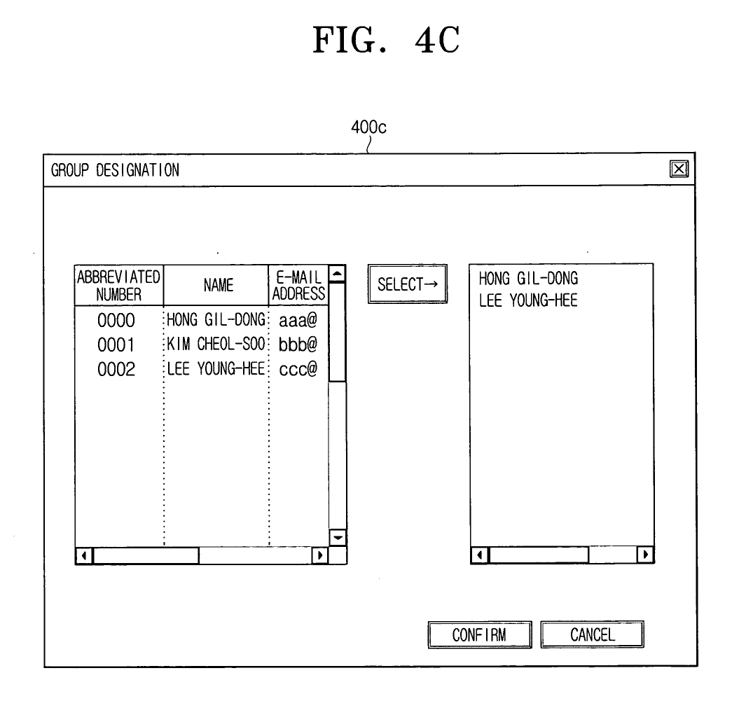

When an abbreviated number registration requesting signal is received from the input device 100 to the first multi-function apparatus 200, the network driver part 160 offers a first menu screen 400a for inputting the abbreviated information on the e-mail address or the facsimile number that will be registered in the first multi-function apparatus 200. As shown in FIG. 4A, the network driver part 160 offers a mail box screen and a facsimile box screen respectively for management of information on e-mails and facsimiles. The information supplied through the first menu screen 400a is the information stored in the storage device of the first multi-function apparatus 200.

The first menu screen 400a is displayed as the mail box screen is selected, and comprises a new address button 410 for inputting abbreviated information for a newly registered e-mail address. Therefore, the user can input the abbreviated information on the e-mail address for new registration in the first multi-function apparatus 200 by selecting the new address button 410.

FIG. 4B illustrates an example of a second menu screen 400b displayed upon selection of the new address button 410 of the first menu screen 400a. The user can input recipient information and originator information on the e-mail address which will be registered, based on the second menu screen 400b. Moreover, the user can select a document which will be transmitted to the e-mail address to be registered by selecting a document selection button 440 provided in the second menu screen 400b. When the document selection button 440 of the second menu screen 400b is selected, the display device 120 displays a list (not shown) illustrating at least one document file already stored in the first multi-function apparatus 200, and using the list displayed on the display device 120, the user can select the document which will be transmitted to the e-mail address to be registered. In this stage, information on the document which will be transmitted, besides the recipient information and originator information on at least one of the e-mail address and the facsimile number, is additionally stored to the abbreviated information which is registered in the first multi-function apparatus 200.

When the abbreviated information on the new e-mail address is input, the network driver part 160 allocates an abbreviated number to the input abbreviated information. The abbreviated number may be allocated using a single abbreviated number allocation method or a group abbreviated number allocation method, the single abbreviated number allocation method in which the abbreviated number is allocated per e-mail address and the group abbreviated number allocation method in which the abbreviated number is allocated per group which comprises a plurality of e-mail addresses. For example, the network driver part 160 allocates the abbreviated number by the single abbreviated number allocation method with respect to information input after selection of the new address button 410 of the first menu screen 400a, and by the group abbreviated number allocation method with respect to information input after selection of a group designation button 420 of the first menu screen 400a.

FIG. 4C illustrates an example of a third menu screen 400c supplied upon selection of the group designation button 420 of the first menu screen 400a. When registering e-mail addresses by group, members of a group may be determined using the information already registered, as shown in the third menu screen 400c. If there are no members registered, the user may directly input the members for grouping.

Additionally, the network driver part 160 offers an editing function for editing registered information on the e-mail addresses and the facsimile number already registered. For example, by selecting an edition key 430 from the first menu screen 400a of FIG. 4A, the user can amend or delete information to be registered or already registered in the first multi-function apparatus 200.

The first NIC 170 controls a communication interface with the plurality of multi-function apparatuses 200 to 200-n connected through the LAN 10. The first NIC should be registered with internet protocol (IP) information of the first multi-function apparatus 200 selected from among the plurality of connected multi-function apparatuses 200 to 200-n by the user. The first NIC 170 transmits to the first multi-function apparatus 200 information on the e-mail address and the facsimile number supplied from the network driver part 160 according to the control of the CPU 150.

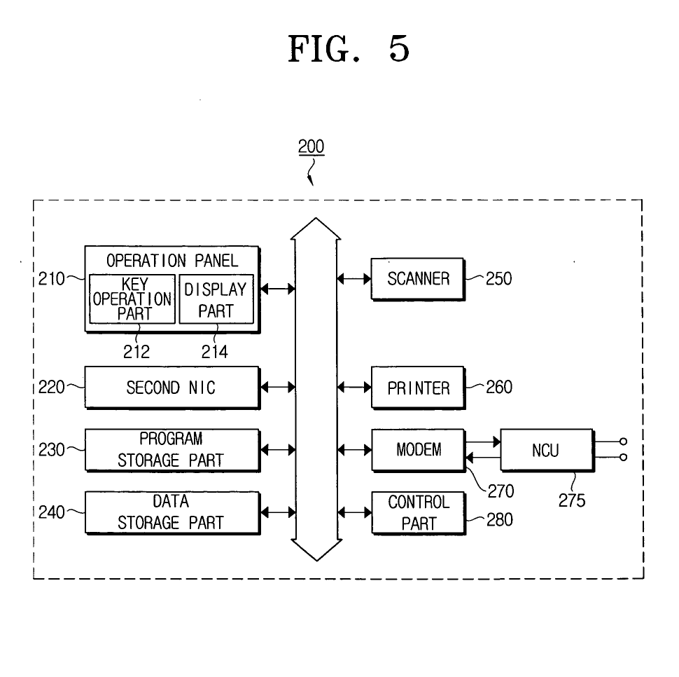

FIG. 5 is a schematic block diagram of the first multi-function apparatus 200 of FIG. 1.

Referring to FIG. 5, the first multi-function apparatus 200 comprises an operation panel 210, a second NIC 220, a program storage part 230, a data storage part 240, a scanner 250, a printer 260, a modem 270, a network control unit (NCU) 275, and a control part 280.

The operation panel 210 comprises a key operation part 212 and a display part 214.

The key operation part 212 is provided with a plurality of keys for selecting or setting functions of the first multi-function apparatus 200, and applies an operation signal according to the key operation to the control part 280. For example, the key operation part 212 may comprise assorted function keys for inputting letters and numbers, and a mode selection key for selecting operation modes of the first multi-function apparatus 200. The operation modes may include a copy mode for copying a certain document, an e-mail transmission mode for transmitting a certain document using an e-mail address, and a facsimile transmission mode for transmitting a certain document using a facsimile number.

The display part 214, controlled by the control part 280, displays the operational states of the first multi-function apparatus 200. In general, an LCD is used as the display part 214.

The second NIC 220 is connectable to the host computer 100 to apply the communication interface with the host computer 100. The second NIC 220, having a unique IP information representing the first multi-function apparatus 200, transceives data only with a computer registered with the IP information on the second NIC 220 from among the plurality of computers connected through the LAN 10.

The second NIC 220 in this embodiment establishes a communication loop with the LAN 10 according to the control of the control part 280 so as to transceive an e-mail with an external mail server (not shown) and apply the e-mail to the control part 280.

The program storage part 230, which is a nonvolatile memory element, stores various controlling programs for performing the functions of the first multi-function apparatus 200.

The data storage part 240 stores the abbreviated information corresponding to the abbreviated number which will registered, which is transmitted from the host computer 100 through the second NIC 220. The data storage part 240 also stores a document scanned by the scanner 250 and a printing document received from the host computer 100 through the second NIC 220.

Table 1 shows the abbreviated number registered in the data storage part 240 by way of example.

TABLE 1

| | | | | docu- | |
|---|---|---|---|---|---|
| | | | | ment | origi- |
| abbre- | | | | for | nator |
| viated | | e-mail | facsimile | trans- | infor- |
| number | name | address | number | mission | mation |
| 0000 | Hong | aaa@samsung.com | | | |
| | Gil- | | | | |
| | dong | | | | |
| 0001 | Kim | bbb@hanmail.net | 02-555-5568 | 111 | |
| | Cheol- | | | | |
| | soo | | | | |
| 0002 | Lee | ccc@hotmai1.net | | | |
| | Young- | | | | |
| | hee | | | | |
| . | . | . | . | . | . |
| . | . | . | . | . | . |
| . | . | . | . | . | . |

As shown in Table 1, the registered abbreviated number comprises at least one abbreviated information such as a receiver name, an e-mail address, a facsimile number, a document to be transmitted, and originator information. The document to be transmitted, selected beforehand during registration of the abbreviated number, refers to a document which will be transmitted to at least one of the e-mail address and the facsimile number corresponding to the selected abbreviated number. In case that the document to be transmitted is included in the abbreviated number 0001 of the Table 1, for example, selected by the user, the pre-stored document 111 is transmitted automatically to at least one of the e-mail address and the facsimile number corresponding to the selected abbreviated number.

The scanner 250, controlled by the control part 280, scans a document, thereby reading image data. The image data read by the scanner 250 is printed by the printer 260 or transmitted to the external device through the modem 270 or the second NIC 220.

The printer 260 prints data according to the control part 280. For example, the printer 260 may print printing data received from the host computer 100 through the second 220 or the image data read by the scanner 250.

The modem 270 converts to an analog signal facsimile data which will be transmitted to an external facsimile, and outputs the analog signal. Also, the modem 270 modulates to digital facsimile data the analog facsimile data transmitted from the external facsimile through the NCU 275, and supplies the digital facsimile data to the control part 280.

The NCU 275 forms a communication channel between a network, such as a public switched telephone network (PSTN), and the modem 270 according to the control part 280 to apply data communication therebetween.

The control part 280 controls overall operations of the first multi-function apparatus 200 according to the controlling programs in the program storage part 230. The control part 280 determines the operation mode of the first multi-function apparatus 200 among the copy mode, the facsimile transmission mode and the e-mail transmission mode, according to the operation signal according to the operation of mode selection keys provided in the key operation part 212.

In addition, when predetermined data is transmitted from the host computer 100 through the second NIC 220, the control part 280 analyzes the data. If the data is to be stored, such as the abbreviated information on one of the e-mail address and the facsimile number, as a result of the analysis, the control part 280 processes the data so that the data is stored in the data storage part 240. If the data is to be printed as a result of the analysis, the control part 280 controls the printer 260 to perform a print job for the transmitted data.

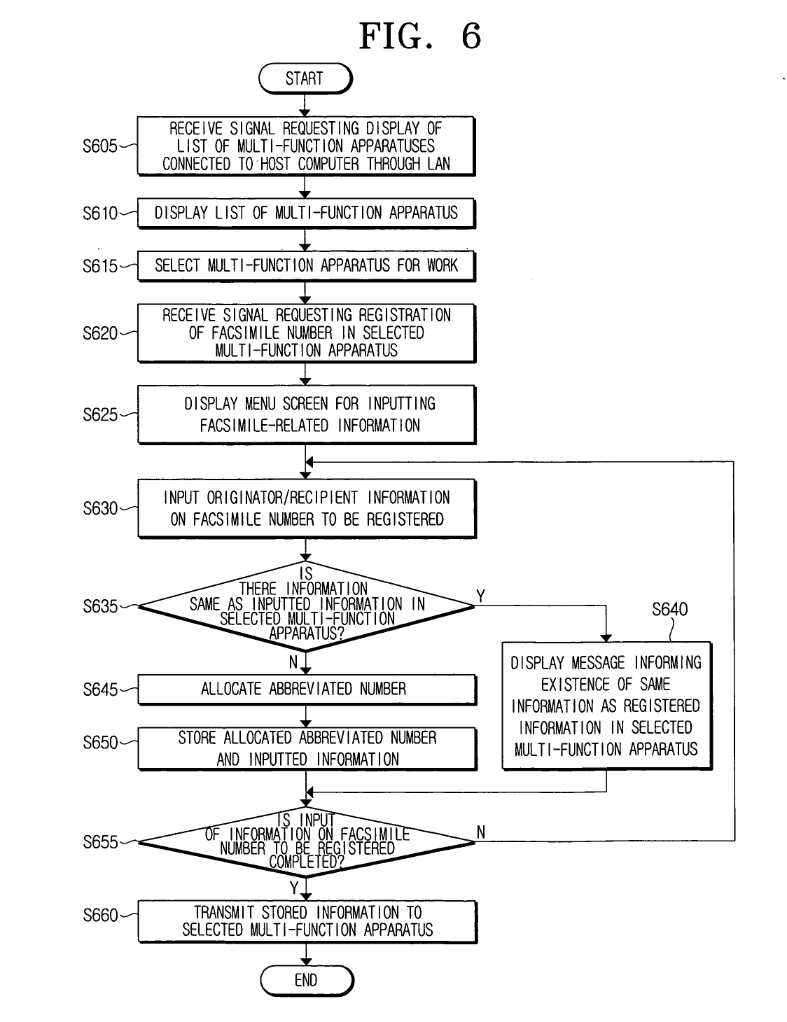

FIG. 6 is a flowchart for explaining a method for registering a facsimile number of methods for registration of abbreviated numbers according to an embodiment of the present invention.

Referring to FIG. 6, upon receiving from the input device 110 a request signal for display of the all list at step S605, the network driver part 160 searches for the multi-function apparatuses connected through the LAN 10 and offers a list of the search result to the user at step S610. Here, the network driver part 160 offers the list separately showing the multi-function apparatuses registered for frequent use and unregistered multi-function apparatuses, as shown in FIG. 3A.

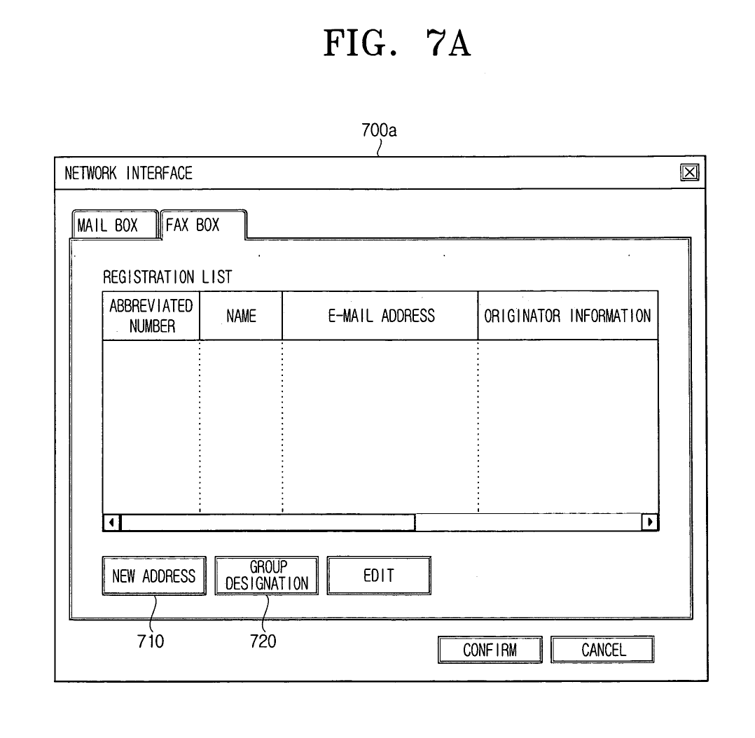

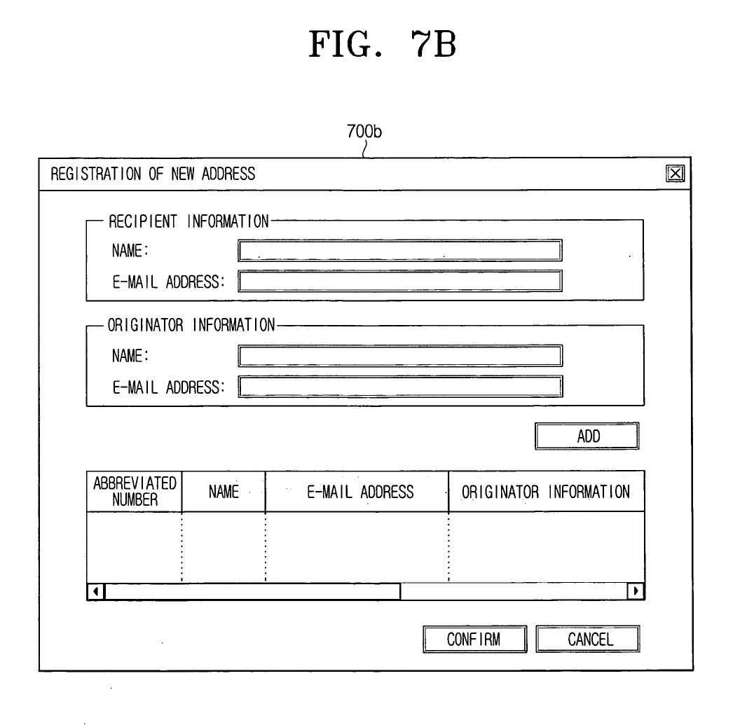

After a multi-function apparatus for work is selected from the list, upon receiving a request signal for registration of a facsimile number in the selected multi-function apparatus at steps S615 and S620, the network driver part 160 offers a fourth menu screen 700a for inputting facsimile-related information, as shown in FIG. 7A at step S625. The user selects a new address button 710 provided in the fourth menu screen 700a and inputs the abbreviated information on the facsimile number which will be registered in the selected multi-function apparatus at step S630. Upon selecting the new address button 710 of the fourth menu screen 700a, a fifth menu screen 700b is displayed, as shown in FIG. 7B, for inputting the originator and recipient information on the facsimile number which will be registered. The user can input the originator and recipient information based on the fifth menu screen 700b.

Whenever the abbreviated information on the facsimile number for registration is input by the user, the network driver part 160 determines whether the multi-function apparatus selected for work has information corresponding to the abbreviated information input through the input device 110 at step S635. That is, the network driver part 160 determines whether a facsimile number the same as the facsimile number for registration has been registered.

At step S635, if the selected multi-function apparatus has information corresponding to the abbreviated information which will be registered, the network driver part 160 displays a message indicating this fact on the display device 120 at step S640.

If it is determined that the selected multi-function apparatus does not have information corresponding to the abbreviated information which will be registered, the network driver part 160 allocates an abbreviated number to the abbreviated information which is newly input at step S645. The network driver part 160 allocates the abbreviated number by the single abbreviated number allocation method with respect to information input after selection of the new address button 710 of the fourth menu screen 700a, and by the group abbreviated number allocation method with respect to information input after selection of a group designation button 720

The abbreviated information given the abbreviated number by the network driver part 160 is temporarily stored in the RAM 140 at step S650. The abbreviated information on the facsimile number which will be registered is completely input as described above at step S655, the network driver part 160 transmits the abbreviated information stored in the RAM 140 to the selected multi-function apparatus through the first NIC 170 at step S660.

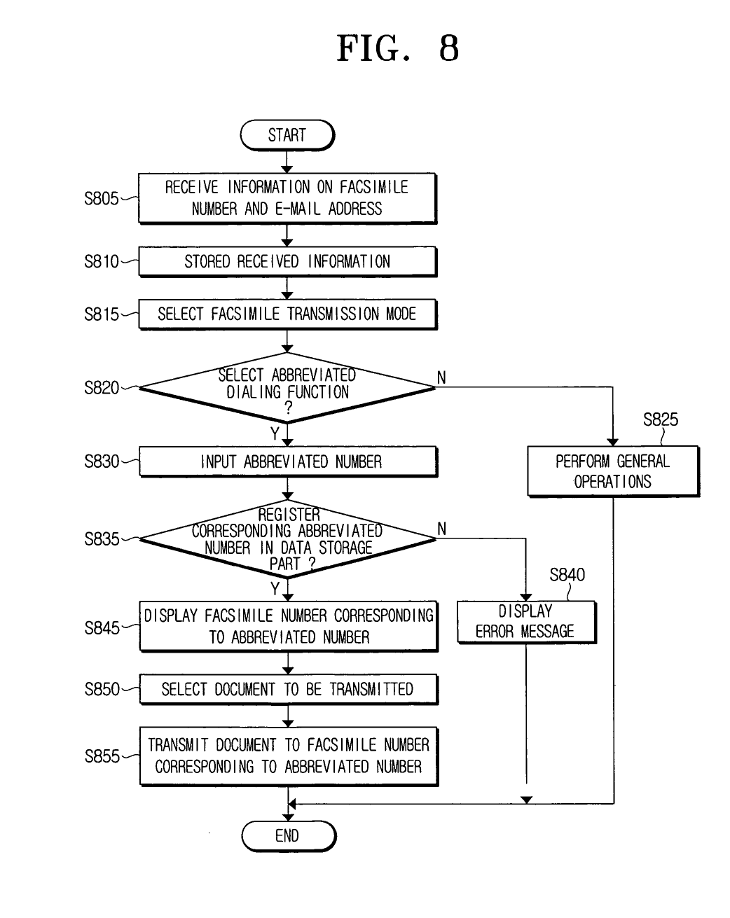

FIG. 8 is a flowchart illustrating a method for facsimile transmission using a first multi-function apparatus 200, thereby explaining a method for controlling the operation of the first multi-function apparatus 200 of FIGS. 1 to 5.

Referring to FIGS. 5 and 8, when an abbreviated information on at least one of the facsimile number and the e-mail address is transmitted from the host computer 100 through the second NIC 220 at step S805, the controlling part 280 stores the received abbreviated information in the data storage part 240 at step S810.

When the facsimile transmission mode is selected through the key operation part 212 at step S815, the controlling part 280 determines whether a signal for selecting an abbreviated dialing function is input through the key operation part 212 at step S820.

If the abbreviated dialing function is not selected at step S820, the controlling part 280 determines the first multi-function apparatus 200 to be in a general dialing mode and performs a conventional facsimile transmission in which the document is transmitted to the facsimile number as input by the user at step S825.

If the abbreviated dialing function is selected at step S820, the control part 280 determines whether the input abbreviated number corresponds to the abbreviated number registered in the data storage part 240 at steps S830 and S835.

If the abbreviated number input by the user does not correspond to the registered abbreviated number, the control part 280 displays an error message indicating this fact on the display part 214 at step S840.

If the abbreviated number input by the user corresponds to the registered abbreviated number, the control part 280 reads the facsimile number corresponding to the abbreviated number input from the data storage part 240, and displays the read facsimile number on the display part 214 at step S845.

When the document to be transmitted is selected at step S850, the control part 280 controls the modem 270 to transmit the selected document to the facsimile number which corresponds to the input abbreviated number (S855). The document to be transmitted may be anyone of the document scanned by the scanner 240, the document pre-stored to the data storage part 240, and the document pre-stored corresponding to the abbreviated number. When the document stored corresponding to the abbreviated number is selected for transmission, the selected document is transmitted automatically to the facsimile number corresponding to the input abbreviated number by the control part 280. Otherwise, the document for transmission is selected directly by the user. When the input abbreviated number includes the originator information, the control part 280 may transmit the document, adding the originator information to a certain part of the transmitted document.

When the abbreviated number input at step S830 is a group abbreviated number, the control part 280 transmits the selected document to at least one of the facsimile numbers included in the group abbreviated number. Of course, if the abbreviated number includes both the e-mail address and the facsimile number, the control part 280 transmits the document to both the facsimile number and the e-mail address.

As can be appreciated from the above description, according to the embodiment of the present invention, it is convenient for use since the multi-function apparatuses registered for frequent use and the unregistered multi-function apparatuses are separately listed. In addition, by enabling registration of the abbreviated number for the e-mail address and the facsimile number through the menu screens provided by the network driver of the host device 100, the user can input the necessary information fast and conveniently.

Furthermore, the originator information is added during registration of the abbreviated number in the multi-function apparatus, and also transmitted together with the transmitted document during facsimile and e-mail transmission. Therefore, the user does not have to prepare the originator information.

While the invention has been shown and described with reference to certain embodiments thereof, it should be understood by those skilled in the art that various changes in form and details may be made therein without departing from the spirit and scope of the invention as defined by the appended claims.

1. A network system for controlling a plurality of peripherals connected to a host device through a network, the network system comprising:
a first interface part for supplying a communication interface for communicating with the plurality of peripherals;
a network driver part for supplying a menu screen for inputting abbreviated information which will be registered in a selected peripheral from among the plurality of peripherals, the abbreviated information comprises at least one of an e-mail address and a facsimile number;
an input part for inputting the abbreviated information; and
a first control part for controlling the network driver part so that the menu screen is supplied upon receipt of a signal from the input part, the signal requesting registration of an abbreviated number in the selected peripheral, and controlling the first interface part so that the abbreviated information input from the input part is transmitted to the selected peripheral based on the menu screen.

2. The network system of claim 1, wherein the abbreviated information comprises at least one of a receiver name, an e-mail address, a facsimile number, a document to be transmitted, and originator information.

3. The network system of claim 1, wherein the network driver part displays a list of the plurality of peripherals connected to the host device through the network according to the requesting signal by a user, the list separately showing the peripherals registered for frequent use and unregistered peripherals.

4. The network system of claim 1, wherein the network driver part allocates an abbreviated number to the input abbreviated information.

5. The network system of claim 4, wherein the plurality of peripherals comprise:
a second interface part for supplying a communication interface for communicating with the host device;
a storage part for storing the abbreviated information allocated with the abbreviated number; and
a second control part, when the abbreviated information is received from the host device through the second interface, for storing the received abbreviated information in the storage part.

6. The network system of claim 5, wherein the plurality of peripherals further comprise:
a first communication module for transceiving a predetermined facsimile document, and
when a predetermined abbreviated number is input by selection of a document transmission function for transmitting a predetermined document to an external device, the second control part reads at least one of e-mail address and a facsimile number corresponding to the input abbreviated number from the storage device, and transmits the document to at least one of the read e-mail address and the facsimile number.

7. A method for registering an abbreviated number in a network system which controls a plurality of peripherals connected to a host device through a network, the method comprising the steps of:
receiving a signal requesting registration of an abbreviated number for at least one of an e-mail address and a facsimile number;
upon receipt of the request signal, supplying a menu screen for inputting abbreviated information on at least one of the e-mail address and the facsimile number;
inputting the abbreviated information for registration in a selected peripheral among the plurality of peripherals based on the menu screen;
allocating an abbreviated number to the input abbreviated information; and
transmitting the abbreviated information allocated with the abbreviated number to the selected peripheral.

8. The method of claim 7, fuirther comprising the steps of:
receiving the abbreviated information transmitted from the host device; and
storing the received abbreviated information in a storage device.

9. The method of claim 8, further comprising the steps of:
selecting a document transmission mode for transmitting a predetermined document to an external device;
inputting an abbreviated number corresponding to information of a recipient;
reading at least one of the e-mail address and the facsimile number which are stored corresponding to the abbreviated number input from the storage device; and
transmitting the read document to at least one of the e-mail address and the facsimile number.

10. The method of claim 7, wherein the menu screen is supplied by a network driver provided in the host device to manage the plurality of peripherals.
